(19) United States
(12) Patent Application Publication
(10) Pub. No.: US 2021/0039987 A1
(43) Pub. Date: Feb. 11, 2021

(54) METHODS FOR MANUFACTURING OF HETEROGENEOUS RIGID ROD NETWORKS

(71) Applicant: Nano-C, Inc., Westwood, MA (US)

(72) Inventors: Ramesh SIVARAJAN, Shrewsbury, MA (US); Melissa J. RICCI, Belmont, MA (US); Colleen E. TREACY, Somerville, MA (US); Viktor VEJINS, Concord, MA (US)

(21) Appl. No.: 16/964,520

(22) PCT Filed: Jan. 23, 2019
(86) PCT No.: PCT/US19/14677

§ 371 Date: Jul. 23, 2020

Related U.S. Application Data
(60) Provisional application No. 62/621,327, filed on Jan. 24, 2018.

(51) Int. Cl. C03C 17/00; C03C 17/10; C03C 17/22; H01B 1/22; H01B 1/24; C09D 11/50; C09D 11/037; C01B 32/159; C01B 32/174

(52) U.S. Cl. CPC C03C 17/008; C01B 2202/22; C03C 17/10; C03C 17/22; H01B 1/22; H01B 1/24; C09D 11/50; C09D 11/037; C01B 32/159; C01B 32/174; C03C 2217/479; C03C 2218/118; C01B 2202/02; C01B 2202/06; C01B 2202/04; C03C 17/007

(57) ABSTRACT

Interlaced random networks of heterogeneous, rigid rod like particles such as metallic nanowires and carbon nanotubes are formed by various methods. The resulting combination provides characteristics that are unique and not attainable by either of the individual components on their own. In one of the embodiments, such heterogeneous networks are continuously formed on a master hot roller surface by application of the rigid rod components from separate sources and the post formed network is transferred fully or partially onto a receptor surface of a moving web directly in-contact with the master surface. In another embodiment the heterogeneous networks are formed on the said master surface or hot roller by applying formulations that are co-stabilized dispersions of heterogeneous, rigid rod like particles in a common solvent. In yet another embodiment, such heterogeneous networks are formed by contacting the receptor surface with more than one such master surface or hot roller.

This patent application claims the benefit of the earlier filing date of U.S. Patent Application No. 62/621,327, filed on Jan. 24, 2018, the contents of which are incorporated by references herein in its entirety.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves all copyright rights.

### FIELD OF INVENTION

The disclosed subject matter is in the field of manufacturing methods for forming random networks of heterogeneous, rigid rod components and other dispersants that are difficult to co-stabilize in a common solvent system suitable for all components, including in the field of transparent conductive films and coatings (TCF) for a wide range of applications covering displays, touch screens, smart windows, sensors, antennas and solar electrodes among others.

The disclosed subject matter is in the field of manufacturing methods for forming random networks of heterogeneous, rigid rod components and other dispersants that are difficult to co-stabilize in a common solvent system, including in the field of transparent conductive films and coatings (TCF) for a wide range of applications covering displays, touch screens, smart windows, sensors, antennas and solar electrodes among others. The term heterogeneous rigid rod networks in the context of this invention refers to the interlaced random networks formed by more than one class or type of particles such as rigid rod like metallic nanowires, carbon nanotubes of different kinds or other particles such as ceramic or polymeric that show different sizes, shapes or aspect ratios. Wherever applicable the term ‘heterogeneous’ also encompasses dispersity in length, diameter, shape etc. within each class of the particles that form the interlaced network. Such networks are also referred to as ‘hybrid networks’, ‘hybrid films’ or ‘hybrids’ in this disclosure. The term common solvent system in this context refers to a solvent that is suitable for dispersing the heterogeneous components.

### BRIEF DESCRIPTION OF THE DRAWINGS

FIG. 1: Schematic of the hot roller surface in continuous contact with a moving substrate in the form of a web. A co-stabilized dispersion of particles is applied by spray head onto the surface of the rotating hot roller. Also shown are lamps at multiple locations emitting infrared radiation that help maintain the temperature of the surface of the hot roller.

FIG. 2: Schematic of the hot roller surface in continuous contact with a moving substrate in the form of a web. Two separate spray heads simultaneously apply dispersions of particles onto the surface of the rotating hot roller. Also shown are lamps at multiple locations emitting infrared radiation that help maintain the temperature of the surface of the hot roller.

FIG. 3: Schematic of multiple hot rollers with surface in continuous contact with a common moving substrate in the form of a web. A first dispersion of particles is applied by spray head onto the surface of the first hot roller and a second dispersion is applied by a spray head onto the surface of a second hot roller. Also shown for each roller are lamps at multiple locations emitting infrared radiation that help maintain the temperature of the surface of the hot roller.

FIG. 4: Schematic of the hot roller surface in continuous contact with a moving substrate in the form of a web. A co-stabilized dispersion of particles is applied by a slot die onto the surface of the rotating hot roller. Also shown are lamps at multiple locations emitting infrared radiation that help maintain the temperature of the surface of the hot roller.

FIG. 5: Schematic of multiple hot rollers with surface in continuous contact with a common moving substrate in the form of a web. A first dispersion of particles is applied by a slot die onto the surface of the first hot roller and a second dispersion is applied by a spray head onto the surface of a second hot roller. Also shown for each roller are lamps at multiple locations emitting infrared radiation that help maintain the temperature of the surface of the hot roller.

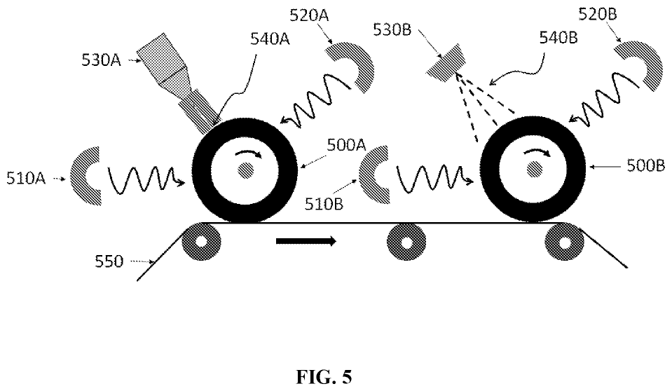

FIG. 6: Scanning electron micrograph of a CNT film deposited on a glass substrate, at a magnification of 10,000×, as described in Example 1.

FIG. 7: Scanning electron micrograph of a CNT film deposited on a glass substrate, at a magnification of 50,000×, as described in Example 1.

FIG. 8: Scanning electron micrograph of a silver nanowire film deposited on a glass substrate, at a magnification of 10,000×, as described in Example 2.

FIG. 9: Scanning electron micrograph of a silver nanowire film deposited on a glass substrate, at a magnification of 50,000×, as described in Example 2.

FIG. 10: Scanning electron micrograph of a CNT-silver mixed hybrid film deposited on a glass substrate, at a magnification of 10,000×, as described in Example 3.

FIG. 11: Scanning electron micrograph of a CNT-silver mixed hybrid film deposited on a glass substrate, at a magnification of 50,000×, as described in Example 3.

FIG. 12: Scanning electron micrograph of a CNT-silver layered hybrid film deposited on a glass substrate, at a magnification of 10,000×, as described in Example 4.

FIG. 13: Scanning electron micrograph of a CNT-silver layered hybrid film deposited on a glass substrate, at a magnification of 50,000×, as described in Example 4.

FIG. 14: Scanning electron micrograph of a CNT-silver dual hybrid film deposited on a glass substrate, at a magnification of 10,000×, as described in Example 5.

FIG. 15: Scanning electron micrograph of a CNT-silver dual hybrid film deposited on a glass substrate, at a magnification of 50,000×, as described in Example 5.

### DESCRIPTION OF THE INVENTION

One of the rigid rod components as part of the dispersion described in [0004] are single walled carbon nanotubes (SWCNT) besides other rigid rod components such as metallic nanorods, high aspect ratio ceramic or polymeric particles.

The aspect ratio, defined by the ratio of the length to the diameter of the particles can be from more than 1 or more than 10 or anywhere from 1 to a million. Non-limiting examples of aspect ratios include about 1:10, 1:100, 1:1,000, 1:2,000, 1:5,000, 1:10,000, and 1:1,000,000. The particles can have a high level of flexibility in spite of such high ratios. All such high aspect ratio particles are referred to as ‘rigid rod’ particles, throughout this specification.

Further non-exhaustive examples of rigid rod particles include single walled carbon nanotubes and their bundles, double walled carbon nanotubes and their bundles, multiwalled carbon nanotubes and bundles formed by them, graphene ribbons and their stacks, metal nanowire made of silver, copper, nickel or alloys of such metals with palladium, gold, high aspect ratio ceramic whiskers, and aramid polymeric molecules among others.

The ability to form dispersions of rigid rod like molecules in aqueous medium or other solvent systems and to further stabilize them over practically useful durations is governed by the interparticle interactions and the interactions of the dispersed particles with the solvent molecules. However, metastable or even stable dispersions of rigid rods can be instantly or eventually destabilized by trace level impurities, heat, radiation, shearing forces or a combination of those. Rigid rods that are instantly destabilized may be destabilized within, for example, seconds, ten minutes, or thirty minutes. In some embodiments, instant destabilization occurs in less than about 30 seconds, less than about one minute, less than about 5 minutes, less than about 10 minutes, or less than about 30 minutes. In some embodiments, instant destabilization occurs in less than about 30 minutes. In some embodiments, instant destabilization occurs in less than about 10 minutes. In some embodiments, instant destabilization occurs in less than about 5 minutes. In some embodiments, instant destabilization occurs in less than about one minute. In some embodiments, instant destabilization occurs in less than about 30 seconds. Rigid rods that are eventually destabilized may be destabilized, for example, within hours, days, or weeks. In some embodiments, eventual destabilization occurs over at least about an hour, a day, or a week. In some embodiments, eventual destabilization occurs over at least about a week. In some embodiments, eventual destabilization occurs over at least about a day. In some embodiments, eventual destabilization occurs over at least about an hour.

Such destabilization can cause irreversible, large scale aggregation resulting in the complete separation of the dispersed phase from the solvent or trigger the formation of microaggregates leading to partial instability. Gradual or sudden loss of solvent thorough natural evaporation or designed evaporation processes can also trigger instability of the dispersed phase before the solvent can be substantially removed through evaporation.

Fabrication of non-woven, random networks of rigid rod particles in the form of supported films on various substrate materials is often carried out by depositing a wet film using a dispersion of the rigid rods in a suitable solvent followed by the evaporation of the solvents out of a wet film deposited on such substrates by a drying process. However, evaporation of solvents through a drying process can trigger instability of the dispersed phase before the solvent can be substantially removed through evaporation, resulting in a poor-quality network or film deposited on the surface

Such destabilization resulting in a poor-quality network or films often happens regardless of the method of deposition such as spin coating, spray coating, slot die coating, gravure coating, dip coating or any similar method wherein a wet film is directly deposited on the target substrate, in particular, plastic substrates that cannot be heated above a certain maximum temperature.

The ability to control such destabilization is further restrained when more than one type of rigid rod particles are present in a common solvent system, e.g., a heterogeneous rod network.

The causes outlined in [0026] and [0027] form major impediments to develop reliable and cost-effective methods for the continuous, roll to roll production of rigid rod networks on a substrate, in particular those consisting of more than one type of high aspect ratio, rigid rod particle.

The current application discloses methods that overcome the difficulties described above and enable the deposition of heterogeneous rigid rod networks on various types of substrates on various types of substrates such as glass, plastics, ceramics and metals.

In particular, the method describes the formation of hybrid films that are electrically conductive and optically transparent.

For one of the embodiments described in this disclosure, the first step is the co-stabilization of different kinds of rigid rod like particles, for example, a population of carbon nanotubes and a population of metal nanowires co-stabilized in one common solvent system. Stabilizing agents, surfactants and co-solvents can be introduced to the mixture to effect stability.

Dispersions of rigid rod like SWCNT in water or other solvent systems has been described in detail by Smalley (U.S. Pat. No. 7,125,502) and the exhaustive list of references cited therein, among others. Sivarajan et al (U.S. Pat. Nos. 9,340,697; 9,296,912) and others (U.S. Pat. No. 8,771,628) have further described inks and dispersions comprising of single walled carbon nanotubes dispersed as a single dispersant, stabilized by a removable molecular additive or a removable non-rigid rod type polymeric additive such as poly-propylene carbonate. Covalent or non-covalent chemical derivatization (also known as functionalization) of carbon nanotubes (single walled, double walled or multiwalled) with various organic derivative groups to disperse them in water or organic solvents with or without the aid of removable or non-removable surfactants and dispersal aids is a well-documented process in the literature. Hence, regardless of the type of the dispersion or the solvent type or the type of the carbon nanotube used for the methods of deposition described in this invention, all such dispersions above are referred to as dispersions of carbon nanotubes.

Stabilized dispersions of silver nanowires in various solvent systems have also been described, including D. A. Dinh et al., Rev. in Adv. Sci. and Eng. 2, 4 (2013). Depositions of these dispersions as conductive electrodes have also been described, as in A. T. Fried et al., 14th International Conference on Nanotechnology, Toronto, ON, 2014, pp. 24-26, and in V. Scardaci et al., Small 7, 18 (2011).

In one of the embodiments, it is envisioned that a population of silver nanowires with or without surfactant or polymeric additives like poly-vinyl pyrrolidine (PVP) can be co-stabilized along with a dispersed population of SWCNT in a common solvent to form a heterogeneous rod dispersion.

In yet another embodiment, it is envisioned that a heterogeneous population of silver nanowires and carbon nanotubes is obtained by co-stabilizing silver nanowires with a co-dispersed population of carbon nanotubes in a solvent system, using one or more of polymers or surfactants. Examples of such surfactants include Poly(methacrylic acid), Poly(acrylic acid), Poly(maleic acid), Poly(vinylphosphonic acid), Poly(styrenesulfonic) acid, Poly(vinylamine) hydrochloride, Poly(L-lysine hydrobromide), Poly(allylamine hydrochloride), Poly(2-vinyl-1-methylpyridinium bromide), Chitosan, Poly(lactic acid), Dextran, Pullulan, Polyethyleneimine, Poly(vinylmenzyl trimethylammonium chloride), Triton X-100, Triton X-35, Brij 98, Brij 58, Brij 35, Tween 20, Sarkosyl, sodium dodecyl sulfate, sodium dodecylbenzenesulfonate, tetrabutylammonium bromide, tetrabutylphosphonium bromide, tetrabutylphosphonium hydroxide, Span 20 by a surfactant chosen from among or wrapped by polymeric additives like poly-vinyl pyrrolidine (PVP) and a host of other polymers such as can be co-stabilized along with a dispersed population of SWCNT in a common solvent.

In yet another embodiment, it is envisioned that a heterogeneous population of silver nanowires and carbon nanotubes is obtained by co-stabilizeing the silver nanowires with a co-dispersed population of carbon nanotubes in a solvent system, aided by a common surfactant including from among those listed in the previous paragraph or in combination of such surfactants with polymeric additives like poly-vinyl pyrrolidine (PVP) or other polymers such as Poly(methacrylic acid), Poly(acrylic acid), Poly(maleic acid), Poly(vinylphosphonic acid), Poly(styrenesulfonic) acid, Polyacrylamide, Polyetherimide, Poly(vinylamine) hydrochloride, Poly(L-lysine hydrobromide), Poly(allylamine hydrochloride), Poly(4-aminostyrene), Poly(ethylene glycol) bis (2-aminoethyl), Poly(2-vinyl-1-methylpyridinium bromide), Chitosan, Poly(lactide-co-glycolide, Poly(lactic acid), Polycaprolactone, Dextran, Cellulose and cellulose derivatives, Pullulan, Polyethylene glycol, Polyethyleneimine, Polyvinyl alcohol, Poly(maleic anhydride), Polyacrylonitrile, Poly(acryloyl chloride), Poly(vinylbenzyl chloride), Poly(vinylmenzyl trimethylammonium chloride).

In yet another embodiment, it is envisioned that the surfactants or stabilizing additives forming part of the heterogeneous film can be removed by washing with water, or a solvent leaving an interconnected network of heterogeneous rigid rods on the substrate surface.

In yet another embodiment, it is envisioned that the film formed by an interconnected network of heterogeneous rigid rods is optically transparent and electrically conductive. Such films can be conveniently referred here throughout this description as hybrid transparent conductive films (Hybrid TCFs).

A vast description of the formation of networks of metallic nanowires or carbon nanotubes is available.

Hybrid TCFs consisting of both metallic nanowires and carbon nanotubes have also been described. For example, hybrid TCFs have been deposited on both glass and polyethylene terephthalate substrates (T. Ackermann et al., The 9th IEEE International Conference on Nano/Micro Engineered and Molecular Systems (NEMS), Waikiki Beach, Hi., 2014, pp. 81-85), used as conductive layers in light-emitting diodes (B. Liu et al, Appl. Phys. Lett. 106, 3 (2015)), and embedded in a curable resin (S. K. R. Pillai et al., Sci. Rep. 6 (2016)). These hybrids TCFs have been shown to be flexible (J. Lee et al., ACS Appl. Mater. Interfaces 6, 14 (2014)) and (T. Tokuno et al., Nanoscale Res. Lett. 7, 1 (2012)) and stretchable (J. Y. Woo et al., Nanotechnology 25, 28 (2014)).

Throughout this specification such interlaced networks formed by metal nanowires and carbon nanotubes of any type including multiwalled, double walled, few walled and single walled are also referred to as metal-CNT hybrid networks or hybrid films. More specifically, when such a network is formed using silver nanowires and carbon nanotubes, they are referred to as silver-CNT hybrids or silver-CNT hybrid films.

Various methods have been proposed for the fabrication of a network formed by heterogeneous rigid rods, in particular interlaced networks formed by carbon nanotubes and metal nanowires are described.

U.S. Pat. No. 8,518,472 B2 describes a method of preparing transparent conductive thin films by slot-die coating double-walled carbon nanotubes onto a substrate, then doping the carbon nanotubes. Silver nanowires may be formed on the substrate on top of the carbon nanotube coating via the polyol method of reducing silver nitrate in the presence of PVP in ethylene glycol. Nanowires may also be formed separately, then dropped onto the coating, or mixed into the carbon nanotube ink before coating. The silver nanowires that are formed will be 17-80 nm in diameter and 2-5 μm in length. These films are shown to improve environmental stability and improve conductivity when compared to neat carbon nanotube films.

US Patent application US 2011/0285019 A1 describes multiple methods of preparing transparent conductive thin films using metallic nanowires coated using conventional techniques. These metallic nanowires can comprise of silver nanowires and carbon nanotubes, although the benefits to such a composite are not described. These films can be prepared on any number of substrates using roll coating, slot die coating, spray coating, or similar coating methods.

U.S. Pat. No. 8,018,563 B2 describes methods of preparing transparent conductive thin films using metallic nanowires. A carbon nanotube layer can be applied above or below the metallic nanowire layer, or co-deposited as an ink directly on a surface.

Publication WO 2016/172315 A1 describes a method of preparing transparent conductive thin films out of metallic nanowires and carbon nanotubes. The metallic nanowires, which may be silver nanowires, are applied as a layer directly onto a substrate by any type of coating including rod, spray, slot-die, or others. The carbon nanotubes are then applied on top of the metallic nanowire coating by any type of printing process including screen printing, aerosol spray, flexographic, or others. These coatings may include any number of additives.

Publication US 2008/0292979 A1 describes a method of preparing transparent conductive thin films out of metallic nanowires. Carbon nanotubes may be blended with the metallic nanowires, or they may be applied to a substrate in alternating discrete layers. These thin films may include photoimageable or photosensitive layers and may be patterned after coating.

US patent US 2014/0308524 A1 describes a method of preparing transparent conductive thin films by alternately depositing carbon nanotube and silver nanowire layers onto a substrate. These coatings may be made with a variety of solvents, and may include binders, resins, or surfactants. Their purpose is to prevent oxidation in the silver nanowire layers, while improving the optical properties of the overall film. A co-dispersed mixture of carbon nanotubes and silver nanowires could not be formed.

All of the methods described above address certain aspects of forming a metal wire-CNT hybrid film. However, a viable pathway for large scale manufacturing of the hybrid film has neither been described by these methods, nor can a method be constructed by combining the various steps.

### BRIEF DESCRIPTION OF THE INVENTION

The term heterogeneous rigid rod networks in the context of this invention refers to the interlaced random networks formed by more than one class or type of particles such as rigid rod like metallic nanowires, carbon nanotubes of different kinds or other particles such as ceramic or polymeric that show different sizes, shapes or aspect ratios. Wherever applicable the term ‘heterogeneous’ also encompasses dispersity in length, diameter, shape etc. within each class of the particles that form the interlaced network. Such networks are also referred to as ‘hybrid networks’, ‘hybrid films’ or ‘hybrids’ in this disclosure. None, one or both of the heterogeneous particles can be rods. Also, composition involving three or more types of particles is contemplated.

A key hurdle faced by solution-based coating or deposition methods for plastic substrates is deposition of high aspect ratio, rigid rod like particles. The slow evaporation of the solvent does not pose any serious problem for non-rigid rod like particles, for example, polymers and ceramic particles dispersed in a solvent. However, high aspect ratio, rigid rod like particles such as metal nanowires and carbon nanotubes face serious instability and segregate even before the solvent is substantially evaporated to form a uniform network of rigid rod dispersants. In some sections of this specification, this problem is referred to as ‘wet film instability.’ The subject application addresses this very issue by providing three types of solutions to mitigate or even completely eliminate the wet film instability problem.

Preferred embodiments of the invention as described herein, feature in the form of a cylindrical roller. The surface of the cylindrical roller is polished to a high degree. The root mean squared (“RMS”) surface roughness of the surface of the cylindrical roller may be, for example, about 0.1-1 μm, 1-10 μm, or 10-100 μm. In some embodiments, the RMS roughness is about 1-100 μm. In some embodiments, the RMS roughness is about 1-10 μm. In some embodiments, the RMS roughness is about 0.1-1 μm. The surface of the cylindrical can be heated to a higher temperature sufficient to evaporate a solvent and to transfer the heterogeneous components onto a plastic substrate. This temperature may range from about 50° C. to 700° C. or about 30° C. to 700° C. and can be achieved by a suitable internal or external heating mechanism well known in the prior art including but not limited to steam, hot fluid circulation, electrical heating or infrared radiation. In some embodiments, the temperature ranges from about 30° C. to 700° C. In some embodiments, the temperature ranges from about 50° C. to 700° C. This component is referred to in this specification simply as hot roller.

In preferred embodiments of the invention as described herein, feature is the formation of a rigid rod network or film on the surface of the said hot roller in a first step which then is transferred by contacting the surface of a plastic substrate in the form of a moving web or a sheet in a second step, wherein the movement of the web or sheet is aided by a different set of rollers. The formation of a rigid rod network or film on the surface of the hot roller may be instant, forming within less than an hour. Formation of the rigid rod network or film on the surface of the hot roller may occur within seconds, ten minutes, or thirty minutes. In some embodiments, instant formation occurs in less than about 30 seconds, less than about one minute, less than about 5 minutes, less than about 10 minutes, or less than about 30 minutes. In some embodiments, instant formation occurs in less than about 30 minutes. In some embodiments, instant formation occurs in less than about 10 minutes. In some embodiments, instant formation occurs in less than about 5 minutes. In some embodiments, instant formation occurs in less than about one minute. In some embodiments, instant formation occurs in less than about 30 seconds.

In one of the embodiments of the invention, application of a suspension of particles of heterogeneous nature in a common solvent, where one or more suspended components are in the form of a rigid rod and the said suspension on to the surface of the hot roller. The said suspension can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use.

In a preferred embodiment, the said single pot dispersion, regardless of stable, semi-stable or poorly stable nature, is applied on to the surface of the hot roller by means of, slot die coating or air spray method or ultrasonic spray method. For example, when the viscosity of the dispersion is greater than 10 centipoise and not suitable for spray coating the dispersion can be applied on to the surface of the hot roller by means of slot-die coating.

In another embodiment of the invention, when the dispersion of the heterogeneous components cannot be obtained in the form of a single pot due to the non-compatibility of the solvent systems or due to the nature of the electrical charges carried by the suspended particles, more than one dispersion from multiple pots can be applied from different storage systems onto the surface of the hot roller simultaneously. The individual dispersions regardless of stable, semi-stable or poorly stable nature can be applied on to the surface of the hot roller by means of slot die coating, air spray method or ultrasonic spray method.

In one other embodiment of the invention, when the dispersion of the heterogeneous components from multiple storage pots cannot be applied onto the surface of a single hot roller, either due to the non-compatibility of the solvent systems or due to their different boiling point and evaporation rates, the individual components can be applied onto the surface of different set of hot rollers by means of slot die coating, air spray or ultrasonic spray coating, however to be followed by the transfer of the separate films thus formed on to the moving surface a common, single substrate in the form of a moving web or sheet in direct contact.

### DETAILED DESCRIPTION OF THE INVENTION

Interlaced random networks of heterogeneous, rigid rod like particles such as metallic nanowires and carbon nanotubes are formed by various methods. The resulting combination provides characteristics that are unique and not attainable by either of the individual components on their own. In one of the embodiments, such heterogeneous networks are continuously formed on a master hot roller surface by application of the rigid rod components from separate sources and the post formed network is transferred fully or partially onto a receptor surface of a moving web directly in-contact with the master surface. In another embodiment the heterogenous networks are formed on the said master surface by applying formulations that are co-stabilized dispersions of heterogeneous, rigid rod like particles in a common solvent suitable to each all particles. In yet another embodiment, such heterogeneous networks are formed by contacting the receptor surface with more than one such master surface.

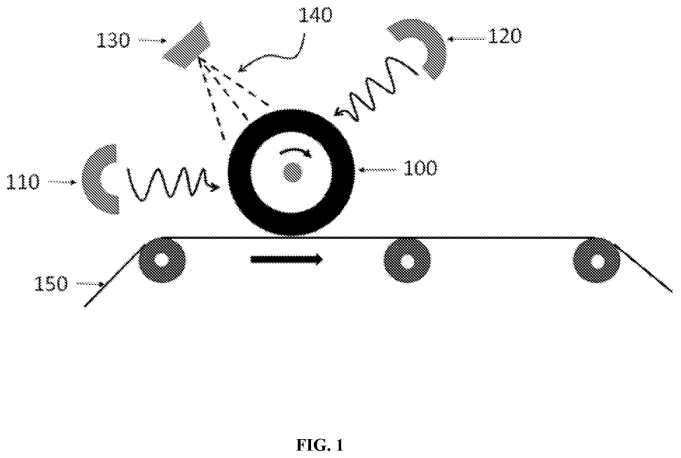

One of the embodiments of the invention is shown in FIG. 1, showing a suspension of particles of heterogeneous nature in a common solvent [140] where one or more suspended components are in the form of a rigid rod and the said suspension is applied on to the hot roller surface [100] using a spray head [130] that can be an air-spray or ultrasonic spray or a combination of those. The said suspension can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use. An instant rigid rod network or a film comprising rigid rod and non-rigid rod particles or a film consisting only of non-rigid rod particles formed on the surface of the hot roller surface [100] in a first step is transferred onto the surface of a flexible plastic substrate in the form of a moving web [150]. In a slightly modified embodiment [150] can be a conveyer belt carrying the substrate in the form of a rigid sheet by contacting in a second step, wherein the movement of the web or sheet is aided by a different set of rollers. Also shown in the figure are infrared heating lamps emitting infrared radiation [110] and [120] that help maintain the temperature of the surface of the hot roller between about 30° C. and 700° C., placed optionally at locations prior to and after the position of the spray head [130].

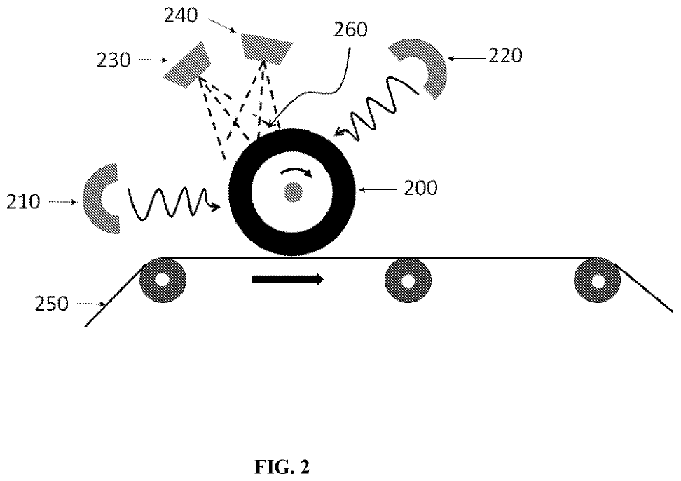

In another embodiments of the invention shown in FIG. 2, more than one dispersion from multiple pots can be applied from different storage systems can be applied simultaneously onto the surface of the hot roller [200] employing more than one spray head, two of which are shown in the figure as [230] and [240]. The individual dispersions regardless of stable, semi-stable or poorly stable nature can be applied on to the surface of the hot roller by means of air spray method or ultrasonic spray method or by a combination of the two. This embodiment may be employed, for example, when the dispersion of the heterogeneous components cannot be obtained in the form of a single pot due to the non-compatibility of the solvent systems or due to the nature of the electrical charges carried by the suspended particles.

The said dispersions applied by means of independent spray heads [230] and [240] can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use. An instant rigid rod network or a film resulting from the combined spray mixture [260] comprising rigid rod and non-rigid rod particles or a film consisting only of non-rigid rod particles formed on the surface of the hot roller surface [200] in a first step is transferred onto the surface of a flexible plastic substrate in the form of a moving web [250]. In a slightly modified embodiment [250] can be a conveyer belt carrying the substrate in the form of a rigid sheet by contacting in a second step, wherein the movement of the web or sheet is aided by a different set of rollers. Also shown in the figure are infrared heating lamps emitting infrared radiation [210] and [220] that help maintain the temperature of the surface of the hot roller between about 30° C. and 700° C., placed optionally at locations prior to and after the position of the spray heads [230] and [240].

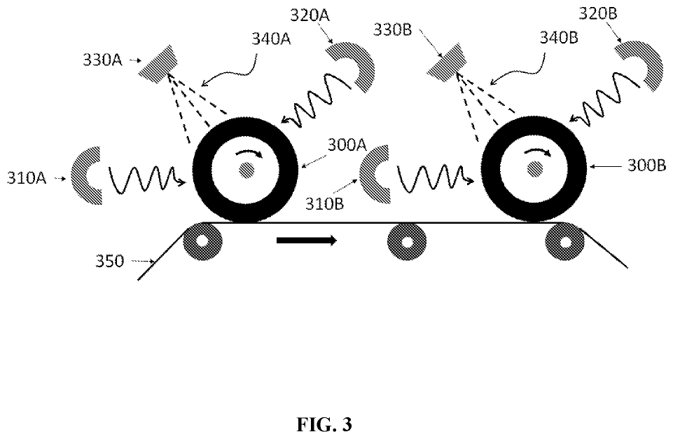

In one other embodiment of the invention as shown in FIG. 3, the individual components are applied onto the surface of different set of hot rollers [300A] and [300B] shown. In this embodiment a first dispersion [340A] applied by means of a first spray head [330A] and [340A] can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use. An instant network or a film comprising only rigid rods, rigid rod particles and non-rigid rod particles or a film consisting only of non-rigid rod particles [200] formed on the surface of the first hot roller surface [300A] is transferred onto the surface of a flexible plastic substrate in the form of a moving web [350]. Also, a second dispersion [340B] applied by means of a second spray head [330B] can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use. An instant network or a film comprising only rigid rods, rigid rod particles and non-rigid rod particles or a film consisting only of non-rigid rod particles [200] formed on the surface of the second hot roller surface [300B] is transferred onto the surface of a flexible plastic substrate in the form of a moving web [350]. In a slightly modified embodiment [350] can be a conveyer belt carrying the substrate in the form of a rigid sheet by contacting in a second step, wherein the movement of the web or sheet is aided by a different set of rollers. Also shown in the figure are sets of heating lamps emitting infrared radiation [310A]/[320A] and [310B]/[320B] that help maintain the temperature of the surface of the hot roller, placed optionally at locations prior to and after the position of the spray heads [330A] and [330B]. This embodiment may be employed when the dispersion of the heterogeneous components from multiple storage pots cannot be applied onto the surface of a single hot roller, either due to the non-compatibility of the solvent systems or due to their different boiling point and evaporation rates.

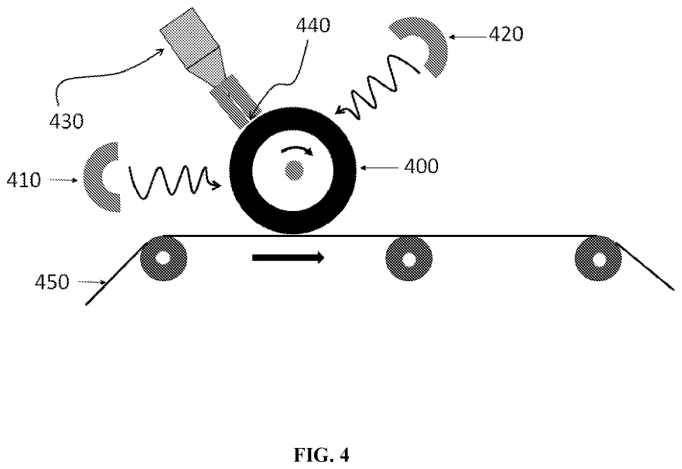

In another embodiment of the invention is shown in FIG. 4, a viscous suspension of particles of heterogeneous nature in a common solvent [430] where one or more suspended components are in the form of a rigid rod and the said suspension is applied on to the hot roller surface [400] using a slot die head [440]. The said suspension can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use. The viscous suspension may have a viscosity of greater than 10 centiPoise. An instant rigid rod network or a film comprising rigid rod and non-rigid rod particles or a film consisting only of non-rigid rod particles formed on the surface of the hot roller surface [400] in a first step is transferred onto the surface of a flexible plastic substrate in the form of a moving web [450]. In a slightly modified embodiment [450] can be a conveyer belt carrying the substrate in the form of a rigid sheet by contacting in a second step, wherein the movement of the web or sheet is aided by a different set of rollers. Also shown in the figure are infrared heating lamps emitting infrared radiation [410] and [420] that help maintain the temperature of the surface of the hot roller, placed optionally at locations prior to and after the position of the slot die coating head [440].

Another embodiment of the invention as shown in FIG. 3 can be employed when the dispersion of the heterogeneous components from multiple storage pots cannot be applied onto the surface of a single hot roller, either due to the non-compatibility of the solvent systems or due to their different boiling point and evaporation rates or one of the suspension is a high viscous liquid not suitable for spray coating. In this case, the individual components are applied onto the surface of different set of hot rollers [500A] and [500B] as shown. In this embodiment a first dispersion [530A] applied by means of a slot die coating head [540A] can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use. An instant network or a film comprising only rigid rods, rigid rod particles and non-rigid rod particles or a film consisting only of non-rigid rod particles formed on the surface of the first hot roller surface [500A] is transferred onto the surface of a flexible plastic substrate in the form of a moving web [550]. Also, a second dispersion [540B] applied by means of a spray head [530B] can be in the form of a co-stabilized, single pot dispersion with a longer shelf stability exceeding one week or a semi-stable single pot dispersion with limited stability not exceeding 24 hours or a poorly stable single pot dispersion which requires mechanical agitation or ultrasonic dispersion at the point of use. An instant network or a film comprising only rigid rods, rigid rod particles and non-rigid rod particles or a film consisting only of non-rigid rod particles formed on the surface of the second hot roller surface [500B] is transferred onto the surface of a flexible plastic substrate in the form of a moving web [550]. In a slightly modified embodiment [550] can be a conveyer belt carrying the substrate in the form of a rigid sheet by contacting in a second step, wherein the movement of the web or sheet is aided by a different set of rollers. Also shown in the figure are sets of heating lamps emitting infrared radiation [510A]/[520A] and [510B]/[520B] that help maintain the temperature of the surface of the hot roller between about 30° C. and 700° C., placed optionally at locations respectively prior to and after the position of the slot die coating head [540A] the spray coating head [530B].

In some embodiments, the target surface is a flexible or rigid metal, glass, ceramic, silicon or plastic substrate. Non-limiting examples of plastic substrates include Polyethylene terephthalate (PET), polyethylene napthalate (PEN), polyvinyl chloride (PVC), polyamide, polyimide, polyethylene, polypropylene, polystyrene, polyacrylonitrile-butadiene-styrene (ABS), polycarbonate, polyurethane, polyvinyl chloride (PVC), polyvinylidene chloride (PVDC), polymethylmethacrylate (PMMA), polyepoxide, phenolics, silicone, polylactic acid (PLA), polyetherether ketone (PEEK), polyetherimide, furan, polysulfone, natural rubber, neoprene, and polybutadiene.

### EXAMPLES

### Example 1: Preparation of a CNT Film Deposited on a Glass Substrate

A prepared dispersion of CNT ink was sonicated in a bath sonicator for 10 minutes. A 3″×2″ sized precleaned glass substrate was heated to 100° C. The CNT ink was deposited on the surface using an ultrasonic spray head with a nozzle frequency of 120 kHz set on a computer-controlled 3-axis robotic arm. The sprayer deposited 50 layers of material amounting to 9.1 ml of CNT ink. The sheet resistance and optical transparency of the sample was measured as follows, after the spray deposition finished.

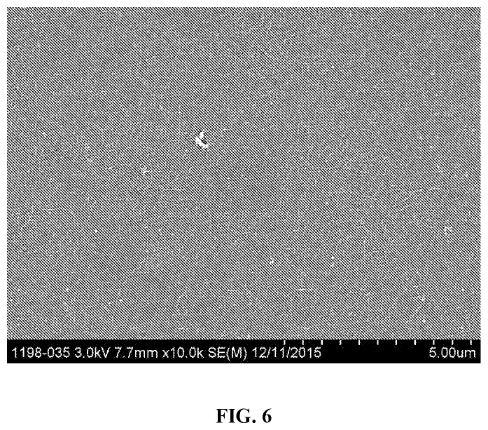

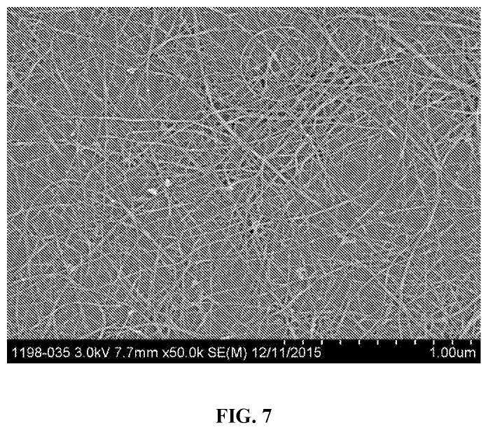

The electrical resistance of the film was measured using a Lucas Labs S-302-4 four-point probe station, with the SP4-40085TBY tip, connected to a Keithley 2100 6½-digit resolution digital multimeter. The observed resistance values were multiplied by a geometric correction factor of 4.53 to obtain the reported sheet resistances expressed in units of ohms/square. Optical transparency of the film was measured using a Shimadzu UV-1601PC UV-visible spectrophotometer, which was baselined with a similar precleaned glass substrate. The CNT film showed a sheet resistance of less than 700 ohms/square at an optical transmittance of more than 80%. The surface and morphology of the CNT film was examined by scanning electron microscopy at different magnitudes. The micrographs of this film at 10,000× and 50,000× magnifications are shown in FIGS. 6 and 7 respectively.

### Example 2: Preparation of a Silver Film Deposited on a Glass Substrate

A commercially available dispersion of silver nanowires of 30 nm diameter and 15 μm length was diluted to a concentration of 50 μg/ml with deionized water, then sonicated in a bath sonicator for 10 minutes. A 3″×2″ sized precleaned glass substrate was heated to 100° C. The silver ink was deposited on the surface using the ultrasonic spray head described in the previous section. The sprayer deposited 195 layers of material amounting to 12.4 ml of silver ink.

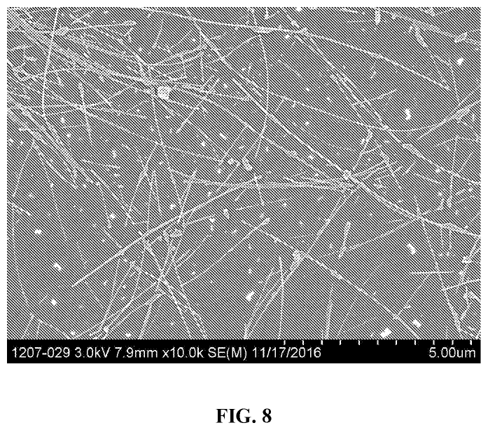

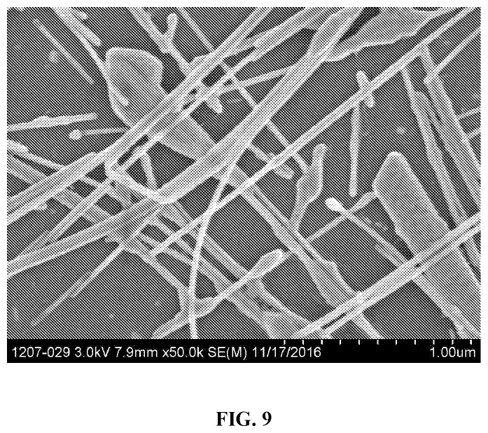

The sheet resistance was measured as described in the previous section. The optical transparency and optical haze were measured using a Qualtech haze meter. The silver film showed a sheet resistance of less than 30 ohms/square at an optical transmittance of more than 91% and an optical haze of 3.1%. The surface and morphology of the silver film was examined by scanning electron microscopy at different magnitudes. The micrographs of this film at 10,000× and 50,000 magnifications are shown in FIGS. 8 and 9 respectively.

### Example 3: Preparation of a CNT-Silver Mixed Hybrid Film Deposited on a Glass Substrate

A commercially available dispersion of silver nanowires of 30 nm diameter and 15 μm length was diluted to a concentration of 50 μg/ml with deionized water. The silver nanowire ink was mixed with a prepared dispersion of CNT ink at a ratio of 7:2 by weight, then sonicated in a bath sonicator for 10 minutes. The successful CNT-silver hybrid ink did not form aggregates.

A 3″×2″ sized precleaned glass substrate was heated to 100° C. The CNT-silver hybrid ink was deposited on the surface using the ultrasonic spray head described in previous sections. The sprayer deposited 195 layers of material amounting to 12.6 ml of CNT-silver mixed hybrid ink.

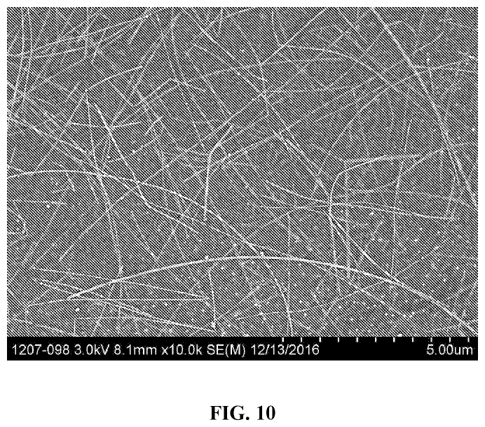

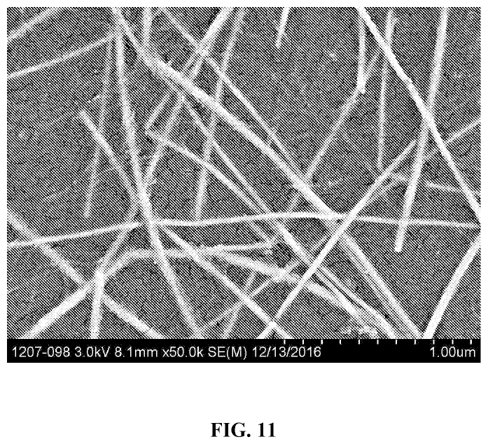

The sheet resistance, optical transparency and optical haze of the samples were measured as described in previous sections using the Lucas Labs S-302-4 four-point probe station and Qualtech haze meter. The CNT-silver mixed hybrid film showed a sheet resistance of less than 40 ohms/square at an optical transmittance of more than 89% and an optical haze of 2.9%. The surface and morphology of the CNT-silver mixed hybrid film was examined by scanning electron microscopy at different magnitudes. The micrographs of this film at 10,000× and 50,000× magnifications are shown in FIGS. 10 and 11 respectively.

### Example 4: Preparation of a CNT-Silver Layered Hybrid Film Deposited on a Glass Substrate

A commercially available dispersion of silver nanowires of 30 nm diameter and 15 μm length was diluted to a concentration of 50 μg/ml with deionized water, then sonicated in a bath sonicator for 10 minutes. A 3″×2″ sized precleaned glass substrate was heated to 100° C. The silver ink was deposited on the surface using the ultrasonic spray head described in previous sections. The sprayer deposited 153 layers of material amounting to 9.7 ml of silver ink. A prepared dispersion of CNT ink was then sonicated in a bath sonicator for 10 minutes. The CNT ink was deposited on the surface using the same ultrasonic spray head. The sprayer deposited 42 layers of material amounting to 2.5 ml of CNT ink.

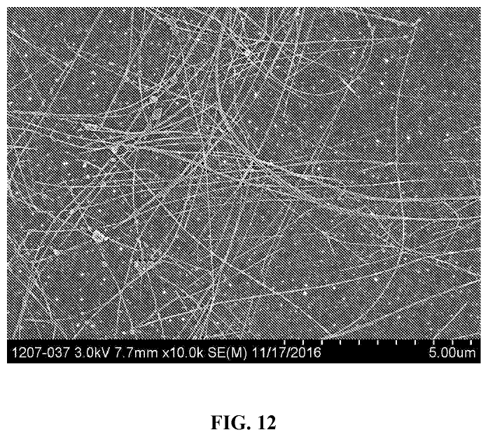

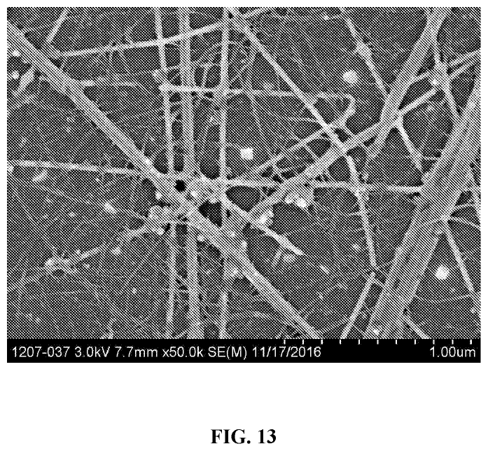

The sheet resistance, optical transparency and optical haze of the samples were measured as described in previous sections using the Lucas Labs S-302-4 four-point probe station and Qualtech haze meter. The CNT-silver layered hybrid films showed a sheet resistance of less than 30 ohms/square at an optical transmittance of more than 87% and an optical haze of 2.1%. The surface and morphology of the CNT-silver layered hybrid film was examined by scanning electron microscopy at different magnitudes. The micrographs of this film at 10,000× and 50,000× magnifications are shown in FIGS. 12 and 13 respectively.

### Example 5: Preparation of a CNT-Silver Dual Hybrid Film Deposited on a Glass Substrate

A commercially available dispersion of silver nanowires of 30 nm diameter and 15 μm length was diluted to a concentration of 50 μg/ml with deionized water, then sonicated in a bath sonicator for 10 minutes. A prepared dispersion of CNT ink was also separately sonicated in a bath sonicator for 10 minutes. A 3″×2″ sized precleaned glass substrate was heated to 100° C. The silver ink and the CNT ink were deposited on the surface using a dual-feed ultrasonic spray head with a nozzle frequency of 120 kHz set on a computer-controlled 3-axis robotic arm. The sprayer deposited 129 layers of material amounting to 8.7 ml of silver ink and 2.4 ml of CNT ink.

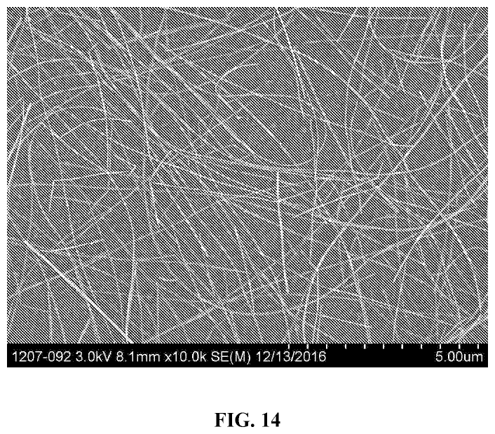

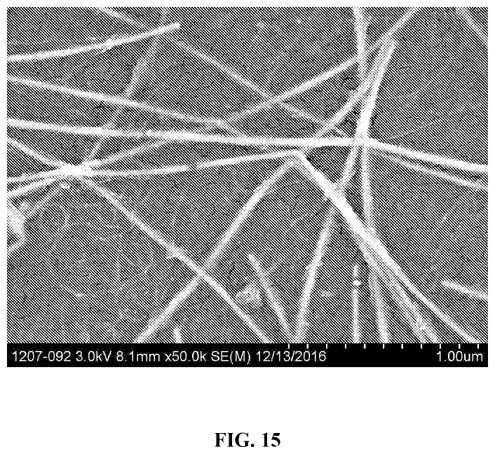

The sheet resistance, optical transparency and optical haze of the samples were measured as described in previous sections using the Lucas Labs S-302-4 four-point probe station and Qualtech haze meter. The CNT-silver dual hybrid films showed a sheet resistance of less than 35 ohms/square at an optical transmittance of more than 91% and an optical haze of 2.3%. The surface and morphology of the CNT-silver dual hybrid film was examined by scanning electron microscopy at different magnitudes. The micrographs of this film at 10,000× and 50,000× magnifications are shown in FIGS. 14 and 15 respectively.

### Example 6: Preparation of a CNT-Silver Hybrid Film Co-Deposited on Polyester

3 mL of a commercially available dispersion of silver nanowires of 30 nm diameter and 15 μm length was bath sonicated for 30 seconds (otherwise used as received), and mixed with 3 mL of a prepared dispersion of CNT ink (optical density=10 @ 550 nm). The CNT ink was bath sonicated 5 min prior to use. The two inks were combined with an equal volume of isopropanol and bath sonicated 30 seconds more.

A 50-micron wet film of the hybrid ink was applied to a polyester film at a coating speed of 30 mm/min and coater hotplate temperature of 65° C., using a rod coater. The wet film was then heated between 65° C. and 100° C. to remove the deposition fluid. Two (2) coats were applied, allowing the deposition fluid to evaporate completely between applications, and rotating the film 180° between the two depositions.

The co-deposited CNT-silver hybrid film showed a sheet resistance of 60-70 ohms/square at an optical transmittance of 93.1% and an optical haze of 1.27%.

### Example 7: Preparation of a CNT-Silver Layered Hybrid Film on Polyester

2.8 mL of a commercially available dispersion of silver nanowires of 30 nm diameter and 15 μm length was added to 6 mL water and bath sonicated for 30 seconds. 8.8 mL isopropanol was added, and was bath sonicated 30 seconds more.

A 50-micron wet film of the silver ink was applied to a 3″×6.5″ polyester film at a coating speed of 30 mm/min and coater hotplate temperature of 65° C., using a rod coater. The wet film was then heated between 65° C. and 100° C. to remove the deposition fluid. Two (2) coats were applied, allowing the deposition fluid to evaporate completely between applications, and rotating the film 180° between the two depositions. The total amount of neat silver ink deposited onto the film was 0.195 mL.

To a 6″×2″ portion of the dried silver nanowire film, preheated to 100° C., was sprayed 18 layers (2.18 mL) of a prepared dispersion of CNT ink (optical density=1 @ 550 nm) after separately sonicating in a bath sonicator for 10 minutes. The CNT ink was deposited on the surface using a single-feed ultrasonic spray head with a nozzle frequency of 120 kHz set on a computer-controlled 3-axis robotic arm.

The CNT-silver layered hybrid films showed a sheet resistance of 62 ohms/square at an optical transmittance of 96.6% and an optical haze of 0.97%.

As will be apparent to one of ordinary skill in the art from a reading of this disclosure, further embodiments of the present invention can be presented in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention. The scope of the invention is as set forth in the appended claims and equivalents thereof, rather than being limited to the examples contained in the foregoing description.

1. A method of depositing a film comprising heterogeneous particles on a target surface, in which the method comprises application by a spray or slot die coating on to the surface of a rotating hot roller, of a dispersion comprising the said heterogeneous particles suspended in a common solvent and which hot roller is in direct in contact with the said target substrate in the form of a moving web or a sheet.

2. The method of claim 1, wherein one of the dispersed, heterogeneous particles is a rigid rod particle having an aspect ratio exceeding about 1.

3. The method of claim 1, wherein one of the dispersed particles is silver nanowires.

4. The method of claim 1, wherein one of the dispersed particles is selected from among the group of single walled carbon nanotubes, double walled carbon nanotubes or multiwalled carbon nanotubes or their chemical derivatives.

5. A method of depositing a film comprising heterogeneous particles on a target surface, in which the method comprises application by spray or slot die coating on to the surface of a rotating hot roller, of a first dispersion comprising one of the heterogeneous particles dispersed in a first solvent followed by the application by spray or slot die coating on to the surface of the same rotating hot roller, of a second dispersion comprising another of the heterogeneous particles dispersed in a second solvent and which hot roller is in direct contact with the said target substrate in the form of a moving web or a sheet.

6. The method of claim 5, wherein one of the dispersed, heterogeneous particles in the first or the second dispersion is a rigid rod like particle having an aspect ratio exceeding about 1.

7. The method of claim 5, wherein one of the dispersed particles in the first or the second dispersion is silver nanowire.

8. The method of claim 5, wherein one of the dispersed particles in the first or the second suspension is selected from among the group of single walled carbon nanotubes, double walled carbon nanotubes or multiwalled carbon nanotubes or their chemical derivatives.

9. A method of depositing a film comprising heterogeneous particles on a target surface, in which the method comprises application by spray or slot die coating on to the surface of a first rotating hot roller, of a first dispersion comprising one of the heterogeneous particles suspended in a first solvent followed by the application by spray or slot die coating on to the surface of a second rotating hot roller, of a second dispersion comprising another of the heterogeneous particles suspended in a second solvent, wherein both the first and second hot rollers are in direct contact with the said target substrate in the form of a moving web or sheet.

10. The method of claim 9, wherein one of the suspended, heterogeneous particles in the first or the second dispersion is a rigid rod like particle having an aspect ratio exceeding 1.

11. The method of claim 9, wherein one of the dispersed particles in the first or the second dispersion is silver nanowire.

12. The method of claim 9, wherein one of the dispersed particles in the first or the second dispersion is selected from among the group of single walled carbon nanotubes, double walled carbon nanotubes or multiwalled carbon nanotubes or their chemical derivatives.
